(19) United States
(12) Patent Application Publication
(10) Pub. No.: US 2011/0185539 A1
(43) Pub. Date: Aug. 4, 2011

(54) MULTIPLE POSITION HANDLE

(76) Inventors: Barry W. Mattson, Elk River, MN (US); James C. Schroeder, Ramsey, MN (US)

(21) Appl. No.: 12/991,452

(22) PCT Filed: Sep. 9, 2009
(86) PCT No.: PCT/US2009/043079

§ 371 Date: Nov. 8, 2010

(51) Int. Cl. B25G 1/04

(52) U.S. Cl. 16/429

(57) ABSTRACT

A frame for a device for applying architectural coatings has a handle which may be mounted in three positions—a storage position, a wheelbarrow position and a normal cart position. The handle may be moved from one position to another by removing a pin, moving the handle to the desired position and reinserting the pin.

### TECHNICAL FIELD

This application claims the benefit of U.S. Application Ser. No. 61/051,467, filed May 8, 2008, the contents of which are hereby incorporated by reference.

### BACKGROUND ART

Airless paint sprayers and other devices for applying architectural coatings (paints, texture materials, roofing materials and the like) have traditionally been mounted on carts having handles which extend upwardly and rearwardly from the frame. It is known to have such handles fold down for more compact storage.

### DISCLOSURE OF THE INVENTION

A frame for a device for applying architectural coatings has a handle which may be mounted in three positions—a storage position, a wheelbarrow position and a normal cart position. The handle may be moved from one position to another by removing a pin, moving the handle to the desired position and reinserting the pin.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the handle of the instant invention in the storage position.

FIG. 2 shows the handle of the instant invention in the wheelbarrow position.

FIG. 3 shows the handle of the instant invention in the normal cart position.

FIG. 4 shows the basic cart frame.

### BEST MODE FOR CARRYING OUT THE INVENTION

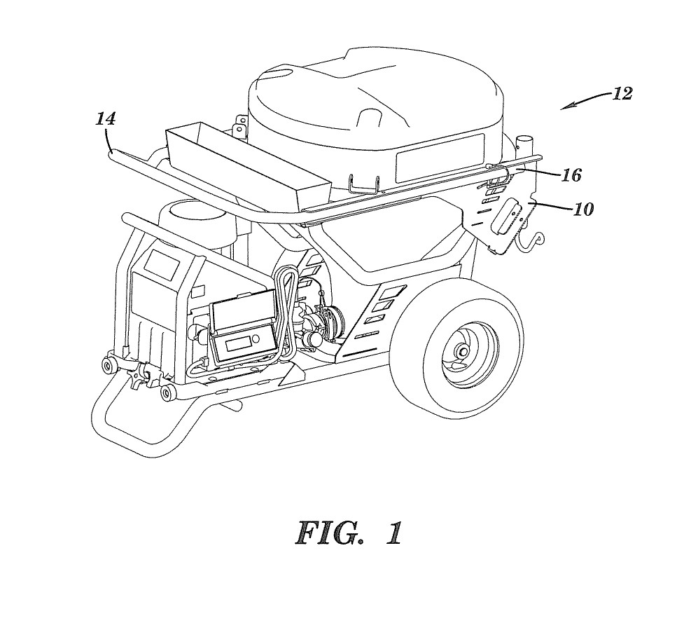

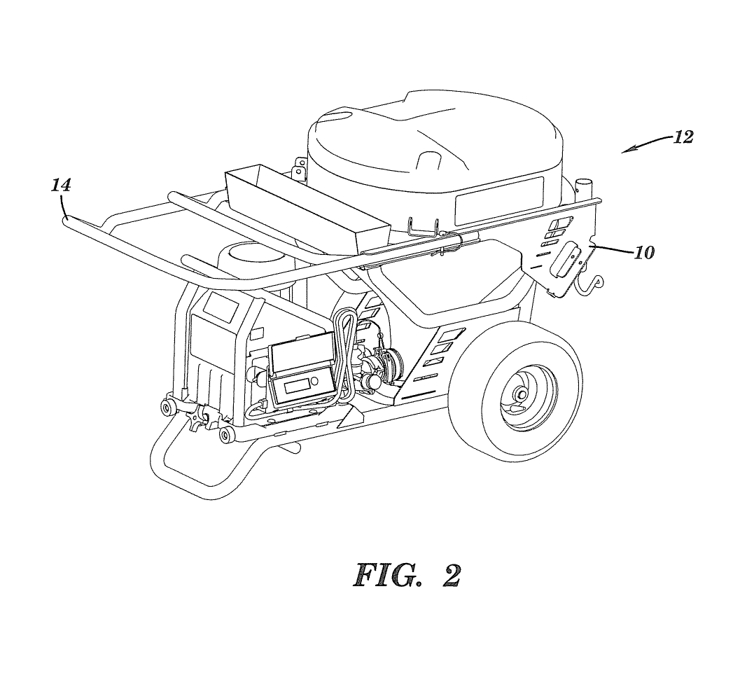

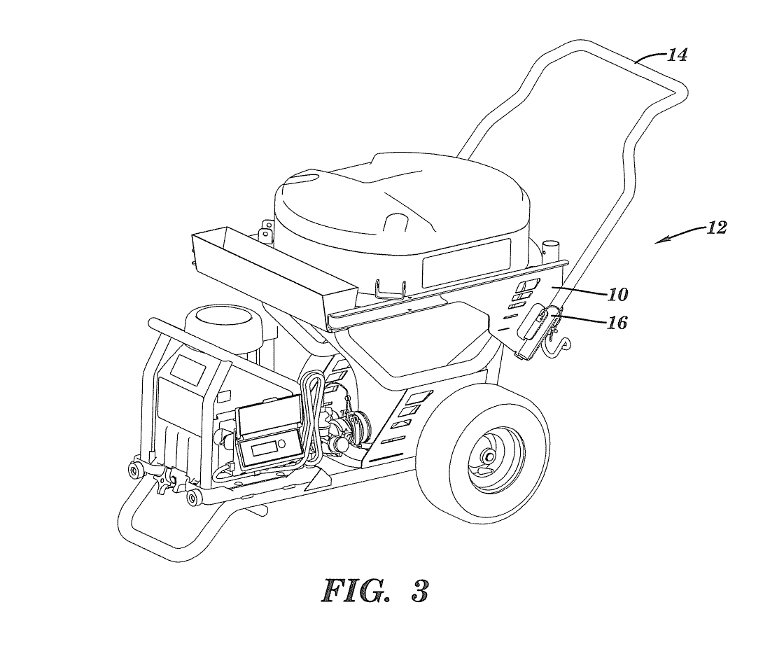

A frame 10 for a device for applying architectural coatings 12 has a handle 14 which may be mounted in three positions—a storage position as shown in FIG. 1, a wheelbarrow position as shown in FIG. 2 and a normal cart position as shown in FIG. 3. The handle 14 may be moved from one position to another by removing a pin or pins 16, moving the handle to the desired position on the frame 10 and reinserting the pin(s) 16.

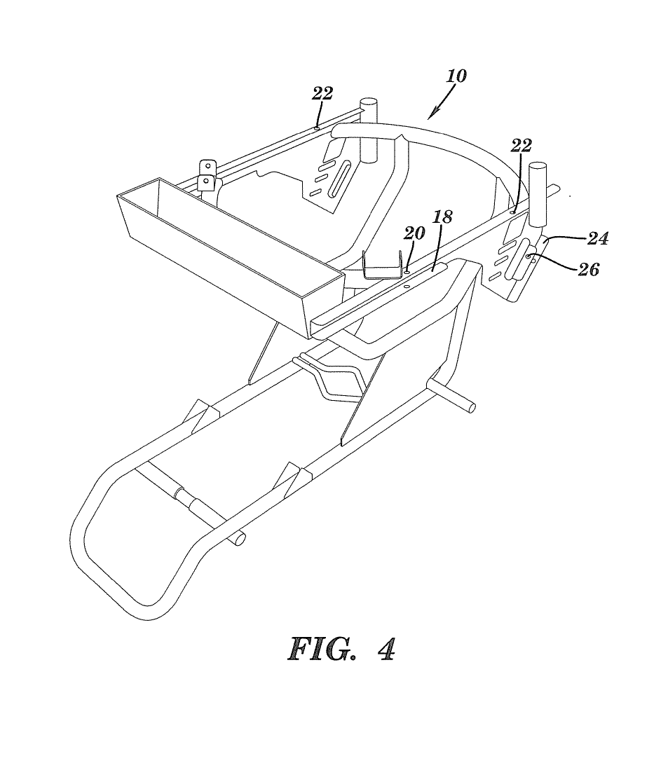

As can be seen in FIG. 4, frame 10 is provided with an upper channel 18 which is provided with first and second sets of holes 20 and 22 for removably receiving pins 16, holes 20 being used to position handle 14 in the wheelbarrow position of FIG. 2 and holes 22 being used to position handle 14 in the storage position of FIG. 1. Similarly, cart channel 24 is provided with holes 26 for removably receiving pins 16 to place the handle 14 in the cart position of FIG. 3.

It is contemplated that various changes and modifications may be made to the cart and handle without departing from the spirit and scope of the invention as defined by the following claims.

1. A frame for a device for applying architectural coatings comprises a handle which may be mounted in at least three positions including a storage position, a wheelbarrow position and a normal cart position and whereby said handle may be moved from one of said positions to another by removing at least one pin, moving said handle to the desired position on said frame and reinserting said pin.

2. The frame for a device for applying architectural coatings of claim 1 further comprising an upper channel comprising first and second sets of holes for removably receiving said pins said first set of holes being used to position said handle in said wheelbarrow position and said second set of holes being used to position said handle in said storage position.

3. The frame for a device for applying architectural coatings of claim 1 further comprising a cart channel provided with holes for removably receiving pins to place said handle in said cart position.
